(19) United States
(12) Patent Application Publication
(10) Pub. No.: US 2005/0160295 A1
(43) Pub. Date: Jul. 21, 2005

(54) Content tampering detection apparatus

(76) Inventor: Koji Sumi, Moriguchi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/033,540

(22) Filed: Jan. 12, 2005

(30) Foreign Application Priority Data
Jan. 15, 2004 (JP) 2004-008428

(51) Int. Cl. H04L 9/00

(52) U.S. Cl. 713/201; 709/224; 713/171; 713/176

(57) ABSTRACT

The present invention provides a content tampering detection apparatus that detects when a previously determined significant tampering is performed on a predetermined content. A content tampering detection apparatus 16 includes: a comparison unit 63 that compares a source content of a homepage, stored in a content storage unit 11, with a backup content stored in a backup storage unit 15, and detect a difference between both contents; a keyword judgment unit 65 that judges whether or not a predetermined keyword is included in a tag indicating an attribute of each difference that is detected, and judges which one of the keywords is included; a weight addition unit that adds up weights assigned to the keywords included in the respective tags of all of the differences that are detected by the comparison unit 63; an alert judgment unit 69 that judges that an alert should be outputted in the case where a total amount obtained by the weight addition unit 67 exceeds a predetermined threshold value; and an alert outputting unit 70 that outputs the alert in the case where it is judged that the alert should be outputted.

### BACKGROUND OF THE INVENTION

(1) Field of the Invention

The present invention relates to a content tampering detection apparatus that detects tampering of a content such as a homepage disclosed over a communication network.

(2) Description of the Related Art

With the widespread use of the Internet in recent years, business enterprises, organizations, and the like, have been providing varied information over the internet through the creation of homepages, and in addition, the number of users utilizing the homepages being provided is also increasing. However, among these users, there also exist hackers that illegally access a Web server on the Internet and tamper with a source content of another person's homepage. For this reason, there exists a Web server that detects tampering of a source content and issues an alert (warning) (refer to official publication of Japanese Laid-Open Patent Application No. 2002-207623, for example). Explanation regarding the Web server (hereinafter referred to as “tampering detection server 100”) having this content tampering detection function shall be made using FIG. 1.

FIG. 1 is a structural diagram of the existing tampering detection server 100. As with a Web server that does not have a tampering detection function, the existing tampering detection server 100 includes a content storage unit 11 that stores a source content of a homepage to be provided to the public over an internet 5, and a reception unit 12 that receives an access by a user. Furthermore, the existing tampering detection server 100 includes an extraction unit 13 that extracts, based on the access by the user, the source content, from the content storage unit 11, and a transmission unit 14 that transmits the extracted source content via the internet 5.

In addition, the existing tampering detection server 100 includes a backup storage unit 15 that stores a backup content which is a backup of the original (pre-tampering) content, and a readout unit 101 that reads out, at predetermined time intervals, the source content and the backup content from the content storage unit 11 and the backup storage unit 15, respectively. In addition, the existing tampering detection server 100 also includes a comparison unit 102 that compares the source content and the backup content read out by the readout unit 101, and detects a difference between both contents, and an alert output unit 103 that transmits an alert to the homepage manager via the internet 5 in the case where there is a difference between the source content and the backup content.

In such an existing tamper detection server 100, the comparison unit 102 checks at a specified time everyday, for example, whether or not there is a difference between the source content and the backup content. If there is even a slight difference, the alert output unit 103 regards the source content as having been tampered with, and transmits an alert to the homepage manager. With this, when the source content is illegally tampered with by an unauthorized user, the homepage manager is able to recognize this fact, and is able to take appropriate measures for the tampering.

### SUMMARY OF THE INVENTION

However, as an alert is transmitted when there is a difference between the source content and the backup content, regardless of the degree of the difference, the manager receiving the alert cannot recognize whether the difference between the aforementioned two contents is big or small. In other words, the manager is unable to judge, just by receiving an alert, whether the tampering of the content is significant or negligible. The homepage manager is interested in finding out about a significant tampering, and not a negligible tampering.

In consideration of the aforementioned issue, the present invention has as an objective to provide a content tampering detection apparatus that detects when a previously determined significant tampering has been performed on a predetermined content.

In order to achieve the aforementioned objective, the content tampering detection apparatus in the present invention is a content tampering detection apparatus that detects tampering of a content provided over a communication network, including: a comparison unit that compares a first content stored in a first storage unit with a second content stored in a second storage unit so as to detect a difference between the first content and the second content, a keyword judgment unit that judges whether or not a predetermined keyword is included in a region, in one of the contents, associated with each difference detected by said comparison unit, an alert judgment unit that judges, based on a judgment made by said keyword judgment unit, whether or not an alert should be outputted, and an alert output unit that outputs an alert in the case where said alert judgment unit judges that the alert should be outputted.

In this manner, the content tampering detection apparatus in the present invention judges whether to output the alert depending on to whether or not the predetermined keyword is included in a region associated with the difference between the first content and the second content. Accordingly, it is possible for the manager of the content to recognize when significant tampering, which the manager has previously determined, is performed on the content by previously establishing keywords for judging whether or not the previously determined significant tampering is performed.

Furthermore, the present invention can also be implemented as a content tampering detection method which has, as steps, the characteristic components of the content tampering detection apparatus of the present invention, or as a program that includes these steps. This program can also be distributed via a storage medium such as a CD-ROM, and a transmission medium such as a communication network.

The present invention can provide a content tampering detection apparatus that detects when a previously determined significant tampering is performed on a predetermined content.

### FURTHER INFORMATION ABOUT TECHNICAL BACKGROUND TO THIS APPLICATION

The disclosure of Japanese Patent Application No. 2004-8424 filed on Jan. 15, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the Drawings:

FIG. 1 is a structure diagram of the existing tampering detection server 100.

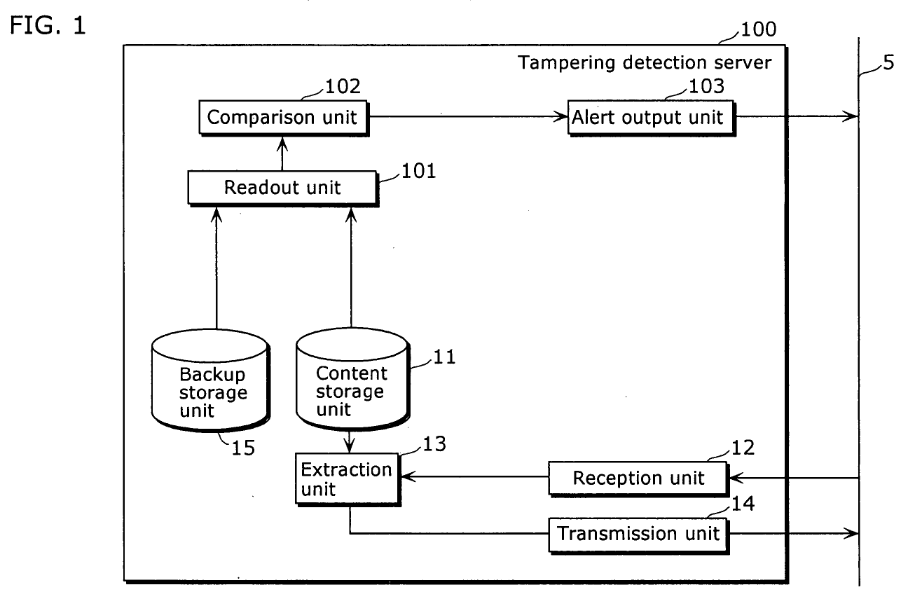

FIG. 2 is a hardware configuration diagram of the content providing system in the first embodiment.

FIG. 3 is a block structure diagram of the server 1 in the first embodiment.

FIG. 4 is a diagram showing an example of the original source content (backup content) of a homepage described through HTML.

FIG. 5 is a diagram showing a specific example of keywords and weights stored in the keyword/weight storage unit 64.

FIG. 6 is a diagram showing an example of a first content (hereinafter referred to as “first tampered content”) after the original source content is tampered with.

FIG. 7 is a diagram showing an example of a second content (hereinafter referred to as “second tampered content”) after the original source content is tampered with.

FIG. 8 is a diagram showing an example of the appearance of the display when an alert is displayed.

FIG. 9 is a flowchart showing the operational flow of the content tampering detection apparatus 16 in the first embodiment.

FIG. 10 is a block structure diagram of the server 91 in the second embodiment.

FIG. 11 is a flowchart showing the operational flow of the content tampering detection apparatus 92 in the second embodiment.

### DESCRIPTION OF THE PREFERRED EMBODIMENT(S)

Hereinafter, the preferred embodiments of the present invention shall be explained with reference to the diagrams.

### First Embodiment

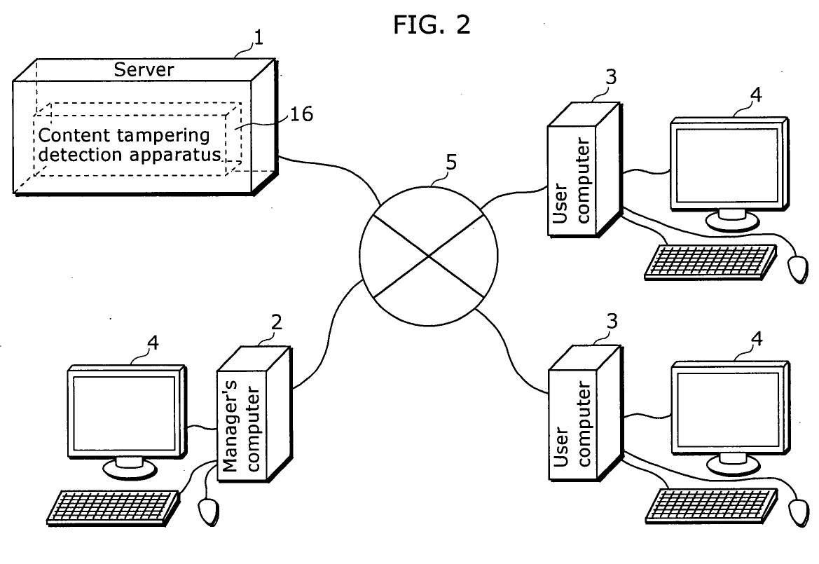

First, the configuration of a content providing system in the first embodiment shall be explained using FIG. 2 to FIG. 8.

FIG. 2 is a hardware configuration diagram of the content providing system in the first embodiment. The content providing system is a system that transmits and receives a source content of a homepage (hereinafter, also referred to simply as “source content”). As shown in FIG. 2, the content providing system includes a server 1 that possesses a content tampering detection apparatus 16, a manager's computer 2, a plurality of user computers 3, a plurality of display apparatuses 4 which are respectively connected to the manager's computer 2 and each of the user computers 3, and an internet 5 that interconnects the server 1, the manager's computer 2, and each of the user computers 3.

The server 1 is an apparatus that transmits, based on an access of a user, the source content to the user computer 3 being used by the user. The manager's computer 2 is an apparatus used by a manger of a homepage, and each of the user computers 3 is an apparatus used by a user wanting to view the homepage.

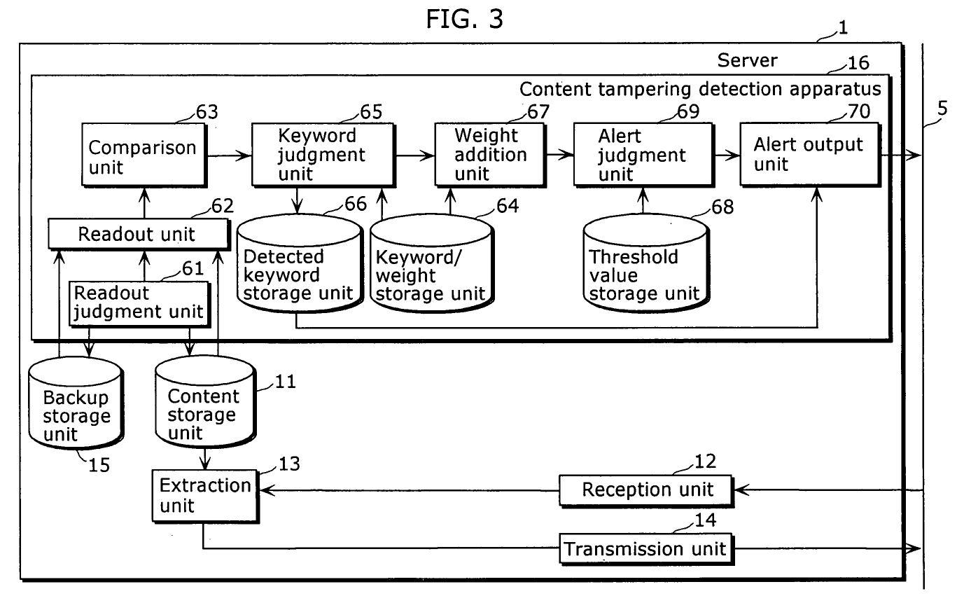

FIG. 3 is a block structure diagram of the server 1 in the aforementioned content serving system. As described above, the server 1 is an apparatus that transmits the source content based on the user's access. As shown in FIG. 3, the server 1 includes a content storage unit 11, a reception unit 12, an extraction unit 13, a transmission unit 14, a backup storage unit 15, and a content tampering detection apparatus 16.

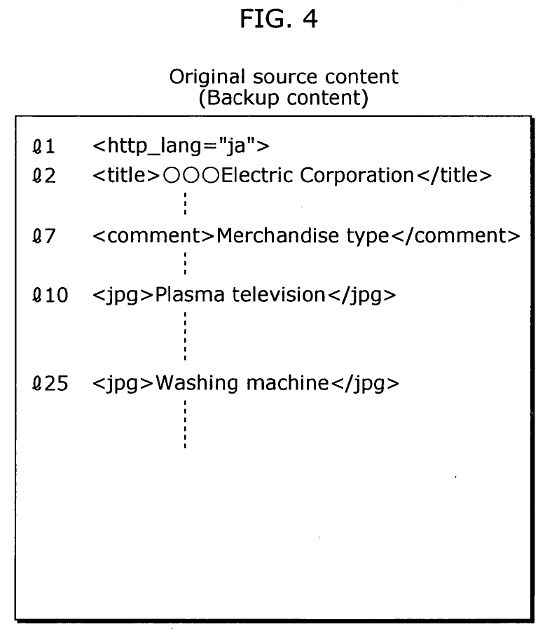

The content storage unit 11 stores the source content of the homepage to be provided to the public over the internet 5, and is an example of a first storage unit. In the first embodiment, the original (pre-tampering) source content is assumed to be described through Hyper Text Markup Language (HTML). A specific example for the original source content shall be discussed later using FIG. 4. In addition, it is assumed that it is possible for the content storage unit 11 to be illegally accessed by a user that does not have authority to rewrite the source content.

The reception unit 12 receives the access of a user from the user computer 3 being used by the user. The extraction unit 13 extracts the source content from the content storage unit 11, based on the access of the user received by the reception unit 12. The transmission unit 14 transmits, via the internet 5, the source content extracted by the extraction unit 13 to the user computer 3 being used by the user. The backup storage unit 15 stores a backup content which is a backup of the original source content, and is an example of a second storage unit. Unlike the content storage unit 11, it is assumed that the backup storage unit 15 cannot be accessed by a user that does not have authority to rewrite the source content. In other words, it is assumed that the backup content cannot be tampered with.

The content tampering detection apparatus 16 is an apparatus that detects tampering when a significant tampering, which is previously determined by the homepage manager, is performed on the original source content. As shown in FIG. 3, the content tampering detection apparatus 16 includes a readout judgment unit 61, a readout unit 62, a comparison unit 63, a keyword/weight storage unit 64, a keyword judgment unit 65, a detected keyword storage unit 66, a weight addition unit 67, a threshold value storage unit 68, an alert judgment unit 69, and an alert output unit 70.

The readout judgment unit 61 accesses the content storage unit 11 and the backup storage unit 15, and judges whether or not the source content and the backup content can be read out one line each at a time. In the first embodiment, it is assumed that the original source content and the backup content can be read out one line each at time as the original source content is described using HTML and the backup content is a backup of the original source content, as previously mentioned. Accordingly, the source content can be read out one line at time in the case where the source content stored in the content storage unit 11 is the original source content or in the case where it is a content resulting from the tampering of the original source content, using HTML.

The readout unit 62 reads out the source content and backup content, one line each at a time, from the content storage unit 11 and the backup storage unit 15, respectively.

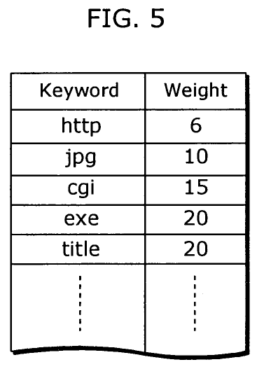

The comparison unit 63 compares the source content with the backup content, read out by the readout unit 62, and detects the difference between the source content and the backup content. The keyword/weight storage unit 64 stores keywords previously selected by the manager of the homepage, and respective weights previously assigned by the manager to each of the keywords. The keywords and the weights are used in judging whether or not tampering performed on the original source content is a significant tampering as previously determined by the manager. A specific example of the keywords and the weights shall be explained later, using FIG. 5.

The keyword judgment unit 65 judges, for each difference detected by the comparison unit 63, whether or not any of the plurality of keywords stored in the keyword/weight storage unit 64 is included in a tag indicating an attribute of the difference, and also judges which keyword is included. The tag is an example of a region associated with the difference. The detected keyword storage unit 66 stores the keyword that is judged by the keyword judgment unit 65 as being included in the tag, as well as the line of the source content which includes the keyword. The weight addition unit 67 adds up the weights assigned to the respective keywords included in the respective tags of the differences detected by the comparison unit 63.

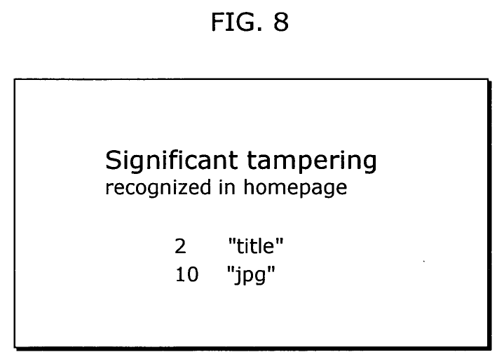

The threshold value storage unit 68 stores a threshold value used as a judgment standard for judging whether or not a significant tampering previously determined by the homepage manager is performed on the original source content. The alert judgment unit 69 checks whether or not the total value obtained by the weight addition unit 67 exceeds the threshold value stored in the threshold value storage unit 68, and judges that an alert should be outputted in the case where the total value exceeds the threshold value, and judges that the alert should not be outputted in the case where the total value is equal to or less than the threshold value. The alert output unit 70 outputs, via the internet 5, an alert to the manager's computer 2 being used by the homepage manager in the case where the alert judgment unit 69 judges that the alert should be outputted. The alert includes respective keywords stored in the detected keyword storage unit 66, and the lines of the source content in which the respective keywords exist. The alert is displayed through the display apparatus 4 connected to the manager's computer 2. A specific example of the alert to be displayed shall be discussed later using FIG. 8.

FIG. 4 is a diagram showing an example of an original source content described through HTML. As shown in FIG. 4, the original source content is text data which describes, using various tags, the patterns such as the size, shape, and color, of words and diagrams within the homepage being displayed. The first embodiment assumes the case in which the source content includes a tag “<http lang=“ja”>” in the first line, a tag “<title>” in the second line, a tag “<comment>” in the seventh line, and a tag “<jpg>” in the tenth and twenty-fifth lines. A number n (n is a positive integer) at the extreme left in FIG. 4 indicates a line number in the source content.

FIG. 5 is a diagram showing a specific example of keywords and weights stored in the keyword/weight storage unit 64. As previously mentioned, the keywords and the weights are used for judging whether or not the tampering performed on the source content is a significant tampering previously determined by the homepage manager. As shown in FIG. 5, “http”, “jpg”, “cgi”, “exe”, “title” are listed as the keywords, and the weights “6”, “10”, “15”, “20”, and “20”, respectively, are assigned to each of the keywords. The keywords are selected by the manager, and the weights are also assigned by the manager. It is assumed that a keyword assigned with a weight having a higher number is considered to be of higher importance to the manager.

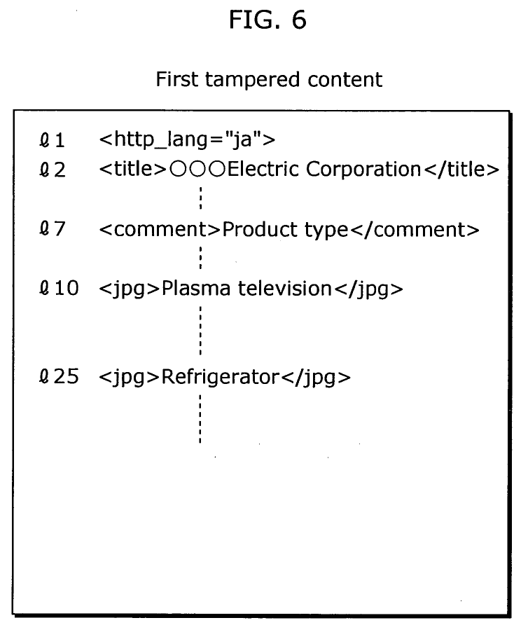

FIG. 6 is a diagram showing an example of a first content (first tampered content) after the original source content shown in FIG. 4 is illegally tampered with by a user that does not have a rewriting authority. As can be made clear through a comparison with the original source content shown in FIG. 4, the first content shown in FIG. 6 is a content in which two areas, namely the seventh and twenty-fifth lines, of the original source content are tampered with.

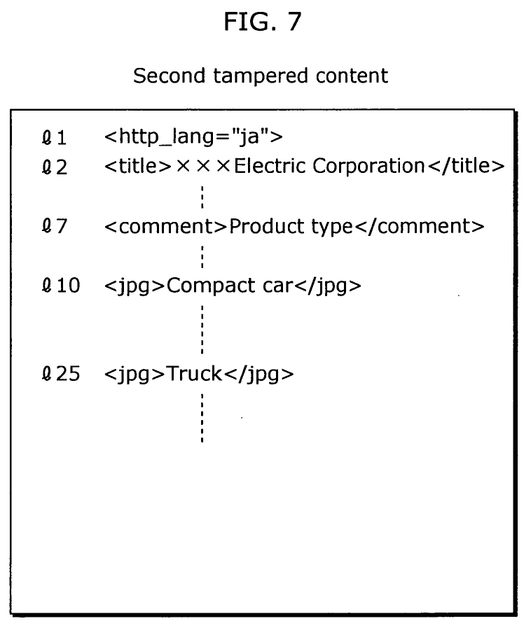

FIG. 7 is a diagram showing an example of a second content (second tampered content) after the original source content shown in FIG. 4 is illegally tampered with by a user that does not have a rewriting authority. As can be made clear through a comparison with the original source content shown in FIG. 4, the second content shown in FIG. 7 is a content in which four areas, namely the second, seventh, tenth, and twenty-fifth lines, of the original source content are tampered with.

FIG. 8 is a diagram showing an example of the appearance of the display when an alert outputted by the alert output unit 70 is displayed on the display apparatus 4 connected to the manager's computer 2. As shown in FIG. 8, when the alert is outputted by the alert output unit 70, the display apparatus 4 connected to the manager's computer 2 displays the words “significant tampering recognized in homepage”. Furthermore, the display apparatus 4 displays the number of the lines that have been tampered with and which tags include keywords stored in the keyword/weight storage unit 64, as well as the included keywords.

Next, the operation of the content providing system in the first embodiment shall be explained.

First, a brief explanation shall be made regarding the operation of the content providing system, when a user attempts to view the homepage.

When attempting to view the homepage, the user accesses the server 1, via the internet 5, through the user computer 3 being used by the user. In the server 1, the reception unit 12 receives the user's access, the extraction unit 13 extracts the source content from the content storage unit 11 based on the user's access received by the reception unit 12, and the transmission unit 14 transmits the source content extracted by the extraction unit 13 to the user computer 3 making the access, via the internet 5. The user computer 3 reproduces the source content using the browser, and the display apparatus 4 connected to the user computer 3 displays the image reproduced from the source content. When the source content is the original source content, the user is able to view the desired homepage.

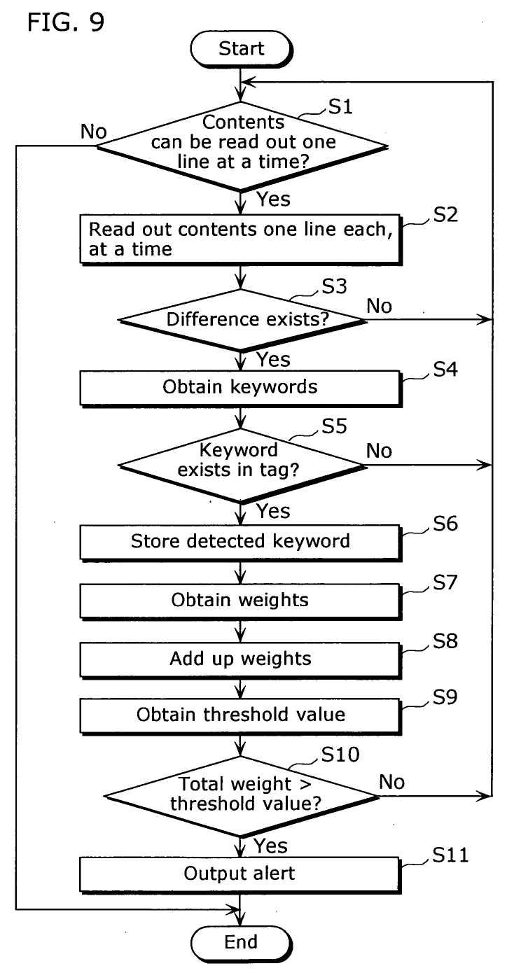

Incidentally, as mentioned earlier, it is possible for the content storage unit 11 to be illegally accessed by a user that does not have authority to rewrite the source content. As such, there is a possibility that the source content stored in the content storage unit 11 is not the original source content, but rather a content resulting from the tampering thereof. This being the case, the operation of the content tampering detection apparatus 16 that detects when the significant tampering previously determined by the homepage manager is performed on the original source content, shall be explained next, using FIG. 9.

FIG. 9 is a flowchart showing the operational flow of the content tampering detection apparatus 16 included in the server 1 in the first embodiment. It is assumed that the content tampering detection apparatus 16 checks, at a specified time everyday (for example, 8:00 everyday), whether or not the significant tampering is performed on the original source content.

Thus, everyday, when the specified time comes, the readout judgment unit 61 accesses the content storage unit 11 and the backup storage unit 15, and judges whether or not the source content stored in the content storage unit 11 and the backup content stored in the backup storage unit 15, respectively, can be read out one line at a time (S1). In the case where both or one of the source content and backup content cannot be read one line at a time (No in S1), the content tampering detection apparatus 16 concludes operation. As previously mentioned, in the first embodiment, the original source content is described using HTML, and being a backup of the original source content, the backup content is also described using HTML. Accordingly, when the source content is the original source content or a content resulting from the tampering of the original source content, using HTML, the source content and backup content can be read out one line at a time (Yes, in S1). In the case such as this, where the source content and backup content can be read out one line at a time (Yes, in S1), the readout unit 62 reads out the source content and the backup content, one line each at a time, from the content storage unit 11 and the backup storage unit 15, respectively (S2).

Next, the comparison unit 63 compares the single line of the source content with the single line of the backup content, read out by the read out unit 62, and checks whether or not there is a difference between the source content and the backup content (S3). When there is no difference (No, in S3), the operation of the content tampering detection apparatus 16 returns to the step (hereinafter referred to as “readout judgment step”) (S1) for judging whether or not reading out one line at a time is possible for the next portions following the respective portions of the source content and the backup content that have already been read out. For example, when the content to be provided to the public is the first tampered content shown in FIG. 6, the first line of the first tampered content and the first line of the backup content shown in FIG. 4 are the same, thus there is no difference between both. Accordingly, in this case, the operation of the content tampering detection apparatus 16 returns to the readout judgment step (S1) for judging whether or not the respective second lines of the source content and the backup content can be read out one line at a time.

In contrast, when there is a difference between the source content and the backup content (Yes, in S3), the keyword judgment unit 65 obtains the plurality of keywords stored in the keyword/weight storage unit 64 (S4). Subsequently, the keyword judgment unit 65 compares the tag indicating the attribute of the difference and the plurality of keywords obtained from the keyword/weight storage unit 64, and judges whether or not any of the plurality of keywords is included in the tag (S5). Furthermore, the keyword judgment unit 65 judges which keyword is included in the tag. As a result, when none of the keywords is included in the tag (No, in S5), the operation of the content tampering detection apparatus 16 returns to the aforementioned readout judgment step (S1).

Here, the source content is assumed to be the first tampered content shown in FIG. 6, and explanation shall be made for a specific example for the case where although there is a difference between the source content and the backup content, none of the keywords stored in the keyword/weight storage unit 64 is included in the tag indicating the attribute of this difference.

Focusing on the seventh lines of the first tampered content (see FIG. 6) and the backup content (see FIG. 4), “<comment>merchandise type</comment>” is listed in the backup content as against “<comment>product type</comment>” listed in the first tampered content. Accordingly, with regard to the seventh lines of the first tampered content and the backup content, the comparison unit 63 detects the difference “product” with respect to the part referred to as “merchandise” in the backup content (Yes, in S3). However, as is clear from the seventh line in FIG. 6, the tag indicating the attribute of the difference “product” is “<comment>”, and none of the keywords stored in the keyword/weight storage unit 64 (see FIG. 5) is included within this tag (No, in S5). As such, the operation of the content tampering detection apparatus 16 returns to the aforementioned readout judgment step (S1).

In contrast, in the case where the keyword judgment unit 65 judges that one of the keywords stored in the keyword/weight storage unit 64 is included in the tag indicating the attribute of the difference (Yes, in S5), the detected keyword storage unit 66 stores this keyword, and the line of the source content which includes this keyword (S6). The weight addition unit 67 obtains the weight assigned to the keyword from the keyword/weight storage unit 64 (S7). In addition, the weight addition unit 67 adds the weight (the weight of the keyword included within the tag indicating the attribute of the difference detected by the keyword judgment unit 65 this time around) obtained from the keyword/weight storage unit 64 to the total value of the weights (aggregate weight up to the previous time) corresponding to the keywords included in the respective tags indicating the attribute of each difference, for all the differences in the respective portions of the source content and backup content that have already been compared (S8). In other words, the weight addition unit 67 obtains the total value of the weights (aggregate weight up to this time) corresponding to the keywords included in the respective tags indicating the attribute of each difference, for all the differences in the respective portions of the source content and backup content that have already been compared up to this time (S8).

Here, the source content is assumed to be the second tampered content shown in FIG. 7, and explanation shall be made for a specific example of the case where aside from having a difference between the source content and the backup content, one of the keywords stored in the keyword/weight storage unit 64 is included in the tag indicating the attribute of the difference.

Focusing on the second lines of the second tampered content (see FIG. 7) and the backup content (see FIG. 4), “<title>OOO Electric Corporation</title>” is listed in the backup content as against “<title>x x x Electric Corporation</title>” listed in the second tampered content. Accordingly, with regard to the second lines of the second tampered content and the backup content, the comparison unit 63 detects the difference “x x x” with respect to the part referred to as “OOO” in the backup content (Yes, in S3). As is clear from the second line in FIG. 7, the tag indicating the attribute of the difference “x x x” is “<title>”, and the keyword “title” stored in the keyword/weight storage unit 64 is included within the tag (Yes, in S5).

Incidentally, as is clear in FIG. 7 and FIG. 4, there is no difference in the first lines of the second tampered content and the backup content. As such, the aggregate weight (aggregate weight up to the previous time) up to the first line of the source content is “0”. Accordingly, the weight addition unit 67 obtains the aggregate weight, up to this time, of “20” by adding, to the previous aggregate weight “0”, the weight “20” (see FIG. 5) of the keyword “title” included within the tag indicating the attribute of the difference (the difference in the respective second lines) detected this time around by the keyword judgment unit 65 (S8).

Focusing on the tenth lines of the second tampered content (see FIG. 7) and the backup content (see FIG. 4), as another example, “<jpg>plasma television</jpg>” is listed in the backup content as against “<jpg>compact car</jpg>” listed in the second tampered content. Accordingly, with regard to the tenth lines of the second tampered content and the backup content, the comparison unit 63 detects the difference “compact car” with respect to the part referred to as “plasma television” in the backup content (Yes, in S3). As is clear from the tenth line in FIG. 7, the tag indicating the attribute of the difference “compact car” is “<jpg>”, and the keyword “jpg” stored in the keyword/weight storage unit 64 is included within the tag (Yes, in S5). Here, when the aggregate weight (aggregate weight up to the previous time) up to the ninth lines of the source content and the backup content is assumed as “20”, the weight addition unit 67 obtains the aggregate weight, up to this time, of “30” by adding, to the previous aggregate weight “20”, the weight “10” (see FIG. 5) of the keyword “jpg” included within the tag indicating the attribute of the difference (the difference in the respective tenth lines) detected this time around by the keyword judgment unit 65 (S8).

Upon obtainment of the aggregate weight up to this time, in the above manner, the alert judgment unit 69 obtains the threshold value stored in the threshold value storage unit 68 (S9), and checks whether or not the total value (aggregate weight up to this time) obtained using the weight adding unit 67 exceeds the obtained threshold value (threshold value stored in the threshold value storage unit 68) (S10). When the aggregate weight up to this time is equal to or less than the threshold value (No, in S10), the alert judgment unit 69 judges that an alert should not be outputted, and the operation returns to the aforementioned readout judgment step (S1).

In contrast, when the aggregate weight up to this time exceeds the threshold value (Yes, in S10), the alert judgment unit 69 judges that an alert should be outputted, and based on this judgment, the alert output unit 70 outputs the alert, via the internet 5, t o the manager's computer 2 being u sed by the homepage manager (S11). During this time, the alert output unit 70 also outputs the respective keywords as well as information identifying the lines of the source content which include the respective keywords, stored in the detected keyword storage unit 66.

The manager's computer 2 displays the alert, from the alert output unit 70, through the display apparatus 4 connected to the manager's computer 2 (see FIG. 8). Accordingly, when a significant tampering that is previously determined by the manager is performed on the source content, the manager is able to recognize this tampering. Furthermore, the manager is able to recognize which part of the source content is tampered with, as the display apparatus 4 displays the number of the lines of the source content that have been tampered with and which tags include the keywords, as well as the included keywords, as shown in FIG. 8.

As mentioned above, the content tampering detection apparatus 16 in the first embodiment compares the source content with the backup content, and judges whether or not keywords selected by the homepage manager are included in respective tags indicating the attribute of the differences between both contents. Subsequently, the content tampering detection apparatus 16 outputs an alert to the manager when the added value of the weights corresponding to the keywords included in the tags exceed the threshold value set by the manager.

For example, as can be seen by comparison with the original source content shown in FIG. 4, two areas, namely the seventh, and twenty-fifth lines, of the first tampered content shown in FIG. 6 are tampered. However, when the manager sets “25” as the threshold value, and the aggregate weight that is obtained by comparing the first tampered content with the backup content is “10”, the aggregate weight does not exceed “25”. Therefore, a significant tampering previously determined by the manager is considered as not having been performed, and an alert is not outputted.

In contrast, the second tampered content shown in FIG. 7 is a content resulting from the tampering of four areas, namely the second, seventh, tenth, and twenty-fifth lines, of the original source content shown in FIG. 4. As such, when the second tampered content and backup content are compared up to their respective ninth lines, the aggregate weight calculated by the weight addition unit 67 is “30”, and thus exceeds “25”. Accordingly, when the original source content is tampered with as in the second tampered content, significant tampering is considered as having been performed on the original source content, so an alert is outputted.

In this manner, the content tampering detection apparatus 16 in the first embodiment does not output an alert in all cases where the original source content is tampered with, and instead outputs an alert only in the case where a significant tampering previously determined by the homepage manager is performed on the original source content. As a result, it is possible for the manager to recognize tampering only when a significant tampering previously determined by the manager is performed on the source content.

Moreover, although in the first embodiment discussed above, the weight addition unit 67 calculates the total value of the weights per single line of the source content, it is also possible to calculate the total value in predetermined portions, instead of on a line-by-line basis. Furthermore, it is also possible for the weight addition unit 67 to obtain the total value of the weights corresponding to respective keywords included in the tags indicating the attributes of all differences, after the entirety of the source content and the entirety of the backup content are compared.

Furthermore, instead of comparing the tag indicating the attribute of each difference with the plurality of keywords contained in the keyword/weight storage unit 64, and judging whether or not any of the plurality of keywords is included in the tag, it is also possible for the keyword judgment unit 65 to perform the judgment described subsequently. That is to say, it is also possible for the keyword judgment unit 65 to compare the difference, per se, and the plurality of keywords, and judge whether or not any of the keywords is contained within the difference. In this case, the weight addition unit 67 obtains the total value of the weights corresponding to the keywords included within each of the differences in the compared portions of the source content and backup content. The difference, per se, is an example of the region associated with the difference. The region associated with the difference is not limited to a tag or the difference per se.

### Second Embodiment

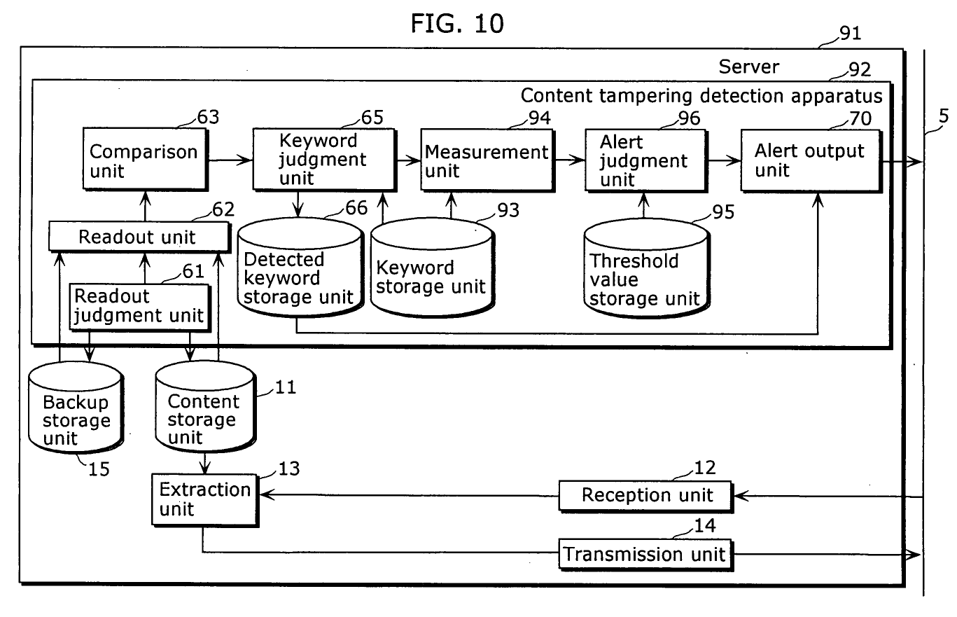

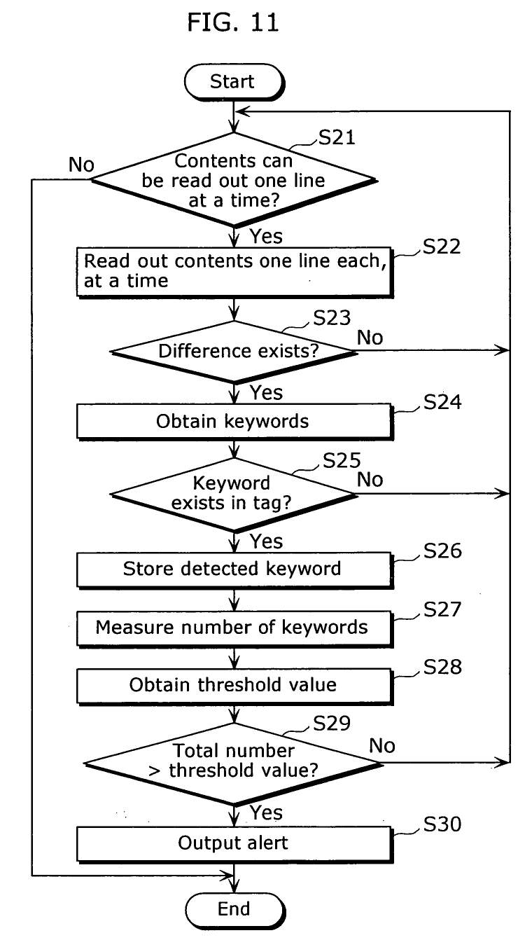

Next, a server 91 and a content tampering detection apparatus 92 in the second embodiment shall be explained using FIG. 10 and FIG. 11.

The content tampering detection apparatus 16 in the first embodiment compares a source content with a backup content, and outputs an alert when the added value of weights corresponding to keywords included in tags which indicate attributes of differences between both contents, exceeds a predetermined threshold value. In contrast, the content tampering detection apparatus 92 in the second embodiment, to be explained in detail later, compares the source content with the backup content, measures the number of keywords that are included in tags indicating the attribute of the differences between both contents, and outputs the alert when the measured number exceeds a predetermined threshold value.

As this is the point of difference between the second embodiment and the first embodiment, explanation in the second embodiment shall center on the point of difference with the first embodiment. In addition, in the second embodiment, components that are the same as the components appearing in the first embodiment shall be assigned the same numbering, and overlapping explanations shall be omitted.

FIG. 10 is a block structure diagram of the server 91 in the second embodiment. The server 91 is an apparatus that transmits a source content based on an access by a user. As shown in FIG. 10, the server 91 includes a content storage unit 11, a reception unit 12, an extraction unit 13, a transmission unit 14, a backup storage unit 15, and a content tampering detection apparatus 92.

The content tampering detection apparatus 92 is an apparatus that detects tampering when a significant tampering, which is previously determined by a homepage manager, is performed on the source content. As shown in FIG. 10, the content tampering detection apparatus 92 includes a readout judgment unit 61, a readout unit 62, a comparison unit 63, a keyword storage unit 93, a keyword judgment unit 65, a detected keyword storage unit 66, a measurement unit 94, a threshold value storage unit 95, an alert judgment unit 96, and an alert output unit 70.

The keyword storage unit 93 stores a plurality of keywords previously selected by the homepage manager. The keywords are used in judging whether or not tampering performed on the original source content is a significant tampering previously determined by the manager. The measurement unit 94 measures the number of keywords that are included in tags indicating attributes of the differences detected by the comparison unit 63.

The threshold value storage unit 95 stores a threshold value used as a judgment standard for judging whether or not a significant tampering previously determined by the homepage manager is performed on the original source content. The alert judgment unit 96 checks whether or not the total number measured by the measurement unit 94 exceeds the threshold value stored in the threshold value storage unit 95, and judges that an alert should be outputted in the case where the total number exceeds the threshold value, and judges that an alert should not be outputted in the case where the total number is equal to or less than the threshold value.

Next, the operation of the content tampering detection apparatus 92 in the second embodiment shall be explained using FIG.

FIG. 11 is a flowchart showing the operational flow of the content tampering detection apparatus 92. The content tampering detection apparatus 92 is assumed to check, at a specified time everyday, whether or not significant tampering is performed on the source content.

Everyday, when the specified time comes, the readout judgment unit 61 accesses the content storage unit 11 and the backup storage unit 15, and judges whether or not the source content stored in the content storage unit 11 and the backup content stored in the backup storage unit 15 can be read out one line at a time (S21). In the case where both or one of the source content and backup content cannot be read one line at a time (No in S21), the content tampering detection apparatus 92 concludes operation. In the case where the source content and backup content can be read out one line at a time (Yes, in S21), the readout unit 62 reads out the source content and the backup content, one line each at a time, from the content storage unit 11 and the backup storage unit 15, respectively (S22).

Next, the comparison unit 63 compares the single line of the source content with the single line of the backup content, read out by the read out unit 62, and checks whether or not there is a difference between the source content and the backup content (S23). When there is no difference (No, in 523), the operation of the content tampering detection apparatus 92 returns to the step (hereinafter referred to as “readout judgment step”) (S21) for judging whether or not reading out one line at a time is possible for the next portions following the respective portions of the source content and the backup content that have already been read out.

In contrast, when there is a difference between the source content and the backup content (Yes, in S23), the keyword judgment unit 65 obtains the plurality of keywords stored in the keyword storage unit 93 (S24). Subsequently, the keyword judgment unit 65 compares the tag indicating the attribute of the difference with the plurality of keywords obtained from the keyword storage unit 93, and judges whether or not any of the plurality of keywords is included in the tag (S25). Furthermore, the keyword judgment unit 65 judges which keyword is included in the tag.

As a result, when none of the keywords is included in the tag (No, in S25), the operation of the content tampering detection apparatus 92 returns to the aforementioned readout judgment step (S21).

In contrast, in the case where one of the keywords stored in the keyword storage unit 93 is included in the tag indicating the attribute of the difference (Yes, in S25), the detected keyword storage unit 66 stores this keyword and the line of the source content which includes this keyword (S26). Subsequently the measurement unit 94 adds the number of keywords (normally “1”) included within the tag indicating the attribute of the difference detected this time around by the keyword judgment unit 65 to the total number (aggregate number up to the previous time) of keywords included in the tags indicating the attribute of respective differences, for all the differences in the respective portions of the source content and backup content that have already been compared (S27). In other words, the measurement unit 94 obtains the total number (aggregate number up to this time) of keywords included in the tags indicating the attribute of respective differences, for all the differences in the respective portions of the source content and backup content that have already been compared up to this time (S27).

Upon obtainment of the aggregate number up to this time, in the above manner, the alert judgment unit 96 obtains the threshold value stored in the threshold value storage unit 95 (S28), and checks whether or not the total number (aggregate number up to this time) obtained by the measurement unit 94 exceeds the obtained threshold value (threshold value stored in the threshold value storage unit 95) (S29). When the aggregate number up to this time is equal to or less than the threshold value (No, in S29), the alert judgment unit 96 judges that an alert should not be outputted, and the operation returns to the aforementioned readout judgment step (S21).

In contrast, when the aggregate number up to this time exceeds the threshold value (Yes, in S29), the alert judgment unit 96 judges that an alert should be outputted, and based on this judgment, the alert output unit 70 outputs the alert, via the internet 5, to the manager's computer 2 being used by the homepage manager (S30). During this time, the alert output unit 70 also outputs respective keywords as well as information identifying the lines of the source content which include the respective keywords, stored in the detected keyword storage unit 66.

The manager's computer 2 displays the alert, from the alert output unit 70, through the display apparatus 4 connected to the manager's computer 2 (see FIG. 8). Accordingly, when a significant tampering previously determined by the manager is performed on the source content, the manager is able to recognize this tampering. Furthermore, the manager is able to recognize which part of the source content is tampered with, as the display apparatus 4 displays the number of the lines in the source content which have been tampered with and which tags include the keywords, as well as the included keywords, as shown in FIG. 8.

As mentioned above, the content tampering detection apparatus 92 in the second embodiment compares the source content with the backup content, and judges whether or not keywords selected by the homepage manager are included in the tags indicating the attributes of the differences between both contents. Subsequently, the content tampering detection apparatus 92 outputs an alert to the manager when the number of keywords included in the tags exceed the threshold value set by the manager.

In other words, the content tampering detection apparatus 92 in the second embodiment does not output the alert in all cases where the original source content is tampered with, and instead outputs the alert only in the case where a significant tampering previously determined by the homepage manager is performed on the original source content. As a result, it is possible for the manager to recognize tampering only when a significant tampering previously determined by the manager is performed on the source content.

Moreover, although in the second embodiment discussed above, the measurement unit 94 measures the total number of keywords, per single line of the source content, it is also possible to measure the total number of keywords in predetermined portions, instead of on a line-by-line basis. Furthermore, it is also possible for the measurement unit 94 to obtain the total number of keywords included in the tags indicating the attributes of all differences after the entirety of the source content and the entirety of the backup content are compared.

Furthermore, it is also possible for the keyword judgment unit 65 to compare the difference, per se, with the plurality of keywords, and judge whether or not any of the keywords is contained within the difference. In this case, the measurement unit 94 obtains the total number of keywords included within each of the differences in the compared portions of the source content and backup content. Here, the difference, per se, is an example of a region associated with the difference. Moreover, the region associated with the difference is not limited to a tag or the difference per se.

Furthermore, the alert judgment unit 96 can also judge that the alert should be outputted immediately in the case where the keyword judgment unit 65 judges that a keyword is included in the region (within a tag or within a difference) associated with the difference.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The content tampering detection apparatus in the present invention possesses the advantage of being able to detect when a previously determined significant tampering is performed on a predetermined content, and is useful as a content tampering detection apparatus that detects tampering of a content of a homepage, and the like, provided over a communication network.

1. A content tampering detection apparatus that detects tampering of a content provided over a communication network, comprising:
a comparison unit operable to compare a first content stored in a first storage unit with a second content stored in a second storage unit so as to detect a difference between the first content and the second content;
a keyword judgment unit operable to judge whether or not a predetermined keyword is included in a region, in one of the contents, associated with each difference detected by said comparison unit;
an alert judgment unit operable to judge, based on a judgment made by said keyword judgment unit, whether or not an alert should be outputted; and
an alert output unit operable to output an alert in the case where said alert judgment unit judges that the alert should be outputted.

2. The content tampering detection apparatus according to claim 1,
wherein the region associated with the difference is a tag, in one of the contents, indicating an attribute of the difference.

3. The content tampering detection apparatus according to claim 1,
wherein the region associated with the difference is the difference per se.

4. The content tampering detection apparatus according to claim 1,
wherein the keyword exists in a plurality, with each of the keywords being assigned a predetermined weight,
said keyword judgment unit is operable to judge which one among the plurality of keywords is the keyword included in the region associated with the difference,
the content tampering detection apparatus further comprises
a weight addition unit operable to add up the weights assigned to the respective keywords included in the respective regions associated with each difference detected by said comparison unit using the judgment made by said keyword judgment unit, and
said alert judgment unit is operable to judge that the alert should be outputted in the case where a total value obtained by said weight addition unit exceeds a predetermined threshold value.

5. The content tampering detection apparatus according to claim 4,
wherein said comparison unit is operable to compare the first content with the second content on a predetermined portion-by-portion basis, starting from respective first portions, so as to detect a difference between each of the portions,
every time said comparison unit finishes comparing each of the respective portions, said weight addition unit is operable to add up the weights assigned to the respective keywords included in the respective regions associated with each of the differences in the portions already compared by said comparison unit, and
every time said weight addition unit finishes adding up the weights, said alert judgment unit is operable to judge whether or not the total value obtained by said weight addition unit exceeds the threshold value, and to judge that the alert should be outputted in the case where the total value exceeds the threshold value.

6. The content tampering detection apparatus according to claim 5,
wherein the predetermined portion is a single text line.

7. The content tampering detection apparatus according to claim 1, further comprising
a measurement unit operable to measure a number of the keywords included in the respective regions associated with each difference detected by said comparison unit,
wherein said alert judgment unit is operable to judge that the alert should be outputted in the case where the number measured by said measurement unit exceeds a predetermined threshold value.

8. The content tampering detection apparatus according to claim 7,
wherein said comparison unit is operable to compare the first content with the second content on a predetermined portion-by-portion basis, starting from respective first portions, so as to detect a difference between each of the portions,
every time said comparison unit finishes comparing each of the respective portions, said measurement unit is operable to measure the number of the respective keywords included in the respective regions associated with each of the differences in the portions already compared by said comparison unit, and
every time said measurement unit finishes measuring the number, said alert judgment unit is operable to judge whether or not the number measured by said measurement unit exceeds the threshold value, and to judge that the alert should be outputted in the case where the measured number exceeds the threshold value.

9. The content tampering detection apparatus according to claim 8,
wherein the predetermined portion is a single text line.

10. The content tampering detection apparatus according to claim 1,
wherein the first content is a source content of a homepage provided over the communication network, and
the second content is a backup of an original of the source content.

11. A server that provides a content over a communication network and detects tampering of the content, comprising:
a first storage unit operable to store a first content;
a second storage unit operable to store a second content;
a transmission unit operable to transmit the first content based on an access of a user,
a comparison unit operable to compare the first content stored in said first storage unit with the second content stored in said second storage unit so as to detect a difference between the first content and the second content;
a keyword judgment unit operable to judge whether or not a predetermined keyword is included in a region, in one of the contents, associated with each difference detected by said comparison unit;
an alert judgment unit operable to judge, based on a judgment made by said keyword judgment unit, whether or not an alert should be outputted; and
an alert output unit operable to output an alert in the case where said alert judgment unit judges that the alert should be outputted.

12. A content tampering detection method for detecting tampering of a content provided over a communication network, comprising:
comparing a first content stored in a first storage unit with a second content stored in a second storage unit so as to detect a difference between the first content and the second content;
judging whether or not a predetermined keyword is included in a region, in one of the contents, associated with each difference detected in said comparing;
judging, based on a judgment made in said keyword judging, whether or not an alert should be outputted; and
outputting an alert in the case where it is judged in said alert output judging that the alert should be outputted.

13. A program for detecting tampering of a content provided over a communication network, the program causing a computer to execute:
comparing a first content stored in a first storage unit with a second content stored in a second storage unit so as to detect a difference between the first content and the second content;
judging whether or not a predetermined keyword is included in a region, in one of the contents, associated with each difference detected in said comparing;
judging, based on a judgment made in said keyword judging, whether or not an alert should be outputted; and
outputting an alert in the case where it is judged in said alert output judging that the alert should be outputted.
